(19) United States
(12) Patent Application Publication
(10) Pub. No.: US 2022/0402515 A1
(43) Pub. Date: Dec. 22, 2022

(54) VEHICLE INSPECTION SYSTEM AND ALIGNMENT METHOD

(71) Applicant: HONDA MOTOR CO., LTD., Minato-ku, Tokyo (JP)

(72) Inventors: Kento Aono, Haga-gun, Tochigi-ken (JP); Kenichiro Kurai, Haga-gun, Tochigi-ken (JP)

(21) Appl. No.: 17/638,890

(22) PCT Filed: Jun. 22, 2020
(86) PCT No.: PCT/JP2020/024406

§ 371 Date: Feb. 28, 2022

(30) Foreign Application Priority Data
Oct. 15, 2019 (JP) 2019-188611

(51) Int. Cl. B60W 50/04; G01B 11/26; B60W 60/00; B60W 30/12; G05B 17/02

(52) U.S. Cl. CPC B60W 50/045; G01B 11/26; B60W 60/001; B60W 30/12; G05B 17/02; B60W 2420/42; B60W 2510/20

(57) ABSTRACT

In this vehicle inspection system for inspecting the driving functionality of a vehicle that carries out automatic driving or driving assistance, when a monitor and the vehicle are being aligned on a bench testing machine, a simulator device displays an image of a straight road on the monitor, a wheel sensor (wheel position sensor) detects the steering direction of a wheel (front wheel) steered using a lane keeping function, and an image position adjustment device (monitor position adjustment device) moves the image in the opposite direction from the steering direction of the wheel until the wheel reaches a neutral state of not being steered.

### TECHNICAL FIELD

The present invention relates to a vehicle inspection system that inspects a driving function of a vehicle performing automated driving or driving assistance, and to an alignment method for aligning the vehicle and a monitor when performing such an inspection.

### BACKGROUND ART

JP 2018-096958 A discloses a system that inspects, inside a room, a driving function of a vehicle performing automated driving or driving assistance, using a camera, radar, LiDAR, and GPS receiver. This system performs the inspection of the automated driving function (driving assistance function) in a state where the vehicle is placed on a bench tester. As an example, in a state where a destination is set in the navigation apparatus of the vehicle, this system inspects whether the vehicle is travelling correctly to the destination by transmitting a pseudo signal indicating the vehicle position to a GPS receiver. Furthermore, this system inspects whether the vehicle is properly braking by capturing an image of a virtual traffic signal with a camera of the vehicle in a state where the vehicle is travelling.

### SUMMARY OF THE INVENTION

A method is considered in which a monitor is arranged directly facing the camera of the vehicle, an image simulating the outside environment is displayed in the monitor, and an inspection is performed concerning whether the driving assistance function or automated driving function is operating correctly according to changes in the image. According to this method, the monitor and the vehicle need be disposed at given positions. In order to precisely specify this prescribed arrangement, it is necessary to position the vehicle with a confronting device. However, manufacturing of a confronting device causes an increase in the cost.

The present invention has been devised in order to solve this type of problem, and has the object of providing a vehicle inspection system and an alignment method that make it possible to align a monitor and a vehicle easily and at a low cost.

A first aspect of the present invention is a vehicle inspection system that inspects a driving function of a vehicle performing automated driving or driving assistance, wherein the vehicle has a lane keeping function for capturing an image of an outdoor environment in front of the vehicle with a camera and keeping a travel position at a prescribed position within a travel lane by performing steering based on the acquired image information, the vehicle inspection system comprising: a bench tester including a wheel accepting mechanism that supports a wheel of the vehicle and accepts a rotating operation and a steering operation of the wheel; a monitor arranged facing the camera; a simulator apparatus that displays an image simulating the outdoor environment on the monitor; a wheel sensor that detects a steering direction of the wheel; and an image position adjusting apparatus that moves the image in a direction of a vehicle width of the vehicle, based on information concerning the steering direction detected by the wheel sensor; wherein when aligning the monitor and the vehicle on the bench tester: the simulator apparatus displays the image of a straight road on the monitor; the wheel sensor detects the steering direction of the wheel steered by the lane keeping function; and the image position adjusting apparatus moves the image in a direction opposite the steering direction of the wheel until the wheel enters a neutral state of not being steered.

A second aspect of the present invention is an alignment method comprising loading onto a bench tester a vehicle that performs automated driving or driving assistance based on image information acquired by a camera, capturing an image simulating an outdoor environment displayed in a monitor with the camera, and aligning the monitor with the vehicle when inspecting a driving function of the vehicle, wherein the vehicle has a lane keeping function for capturing an image of an outdoor environment in front of the vehicle with the camera and keeping a travel position at a prescribed position within a travel lane by performing steering based on the acquired image information, the alignment method comprising: a step of displaying the image of a straight road on the monitor; a step of activating the lane keeping function while capturing the image displayed on the monitor with the camera, and causing the vehicle to travel on the bench tester; a step of detecting a steering direction of a wheel steered by the lane keeping function with a wheel sensor; and a step of moving the image in a direction opposite the steering direction of the wheel, until the wheel is in a neutral state of not being steered.

According to the present invention, it is possible to align the monitor and the vehicle easily at a low cost.

### BRIEF DESCRIPTION OF DRAWINGS

FIG. 1 is an apparatus configuration diagram of a vehicle;

FIG. 2 is a system configuration diagram of a vehicle inspection system;

FIG. 3 is a schematic diagram of a wheel accepting mechanism;

FIG. 4 is a schematic diagram of a monitor apparatus;

FIG. 5 is a flow chart showing a procedure of inspecting a driving function of the vehicle;

FIGS. 6A, 6B and 6C are diagrams showing an image of a virtual outdoor environment displayed in the monitor;

FIG. 7 is a flow chart showing a procedure of an alignment process;

FIG. 8 is a diagram showing an image of a straight road shown in the monitor;

FIG. 9A is a diagram showing a steering direction of a wheel, and FIG. 9B is a diagram showing a movement direction of the monitor; and

FIG. 10 is a flow chart showing a procedure of a lateral skew preventing process.

### DESCRIPTION OF THE INVENTION

Preferred embodiments of a vehicle inspection system and an alignment method according to the present invention will be presented and described below with reference to the accompanying drawings.

### [1. Vehicle 200]

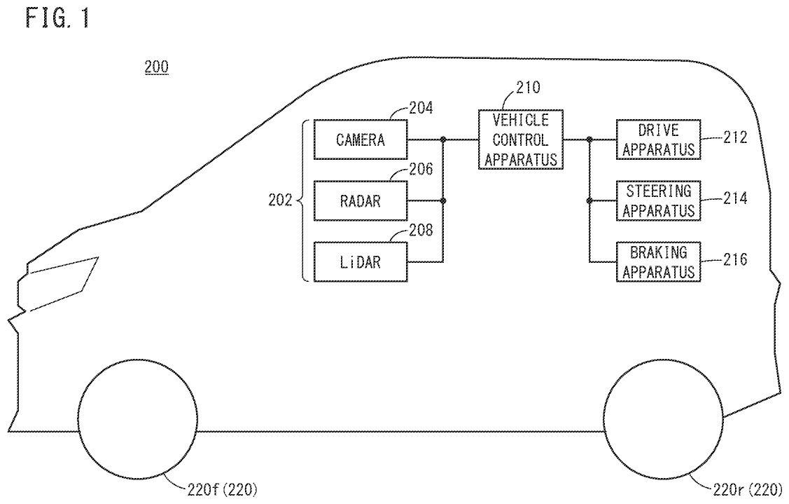

The following describes a vehicle 200 that is an inspection target in the present embodiment, using FIG. 1. The vehicle 200 is a driving assistance vehicle that can automatically control at least the steering from among the acceleration, braking, and steering, based on detection information of an outside sensor 202. The vehicle 200 may be an automated driving vehicle (including a fully automated driving vehicle) that can automatically control the acceleration, braking, and steering based on the detection information of the outside sensor 202 and position information of a GNSS (not shown in the drawings). As shown in FIG. 1, the vehicle 200 includes the outside sensor 202 that detects outside environment information, a vehicle control apparatus 210 that performs travel control of the vehicle 200, a drive apparatus 212, steering apparatus 214, and braking apparatus 216 that operate according to operating instructions output by the vehicle control apparatus 210, and four wheels 220.

The outside sensor 202 includes one or more cameras 204, one or more radars 206, and one or more LiDARs 208 that detect information on the outside environment in front of the vehicle 200. The camera 204 captures an image of the outside environment in front of the vehicle 200. The radar 206 emits radio waves ahead of the vehicle 200 and detects reflected waves that have been reflected by the outside environment. The LiDAR 208 emits laser light ahead of the vehicle 200 and detects scattered light that has been scattered by the outside environment. A description concerning the outside sensor 202 that detects the outside environment information for regions that are not in front of the vehicle 200 is omitted.

The vehicle control apparatus 210 is constituted by a vehicle control ECU. The vehicle control apparatus 210 calculates, based on the information detected by the outside sensor 202 such as the image information acquired by the camera 204, an optimal acceleration, braking amount, and steering angle θs corresponding to various driving assistance functions (lane keeping function, inter-vehicle distance maintaining function, collision reduction braking function, off-road deviation restricting function, and the like), and outputs operation instructions to various control target apparatuses.

The drive apparatus 212 includes a drive ECU and a drive source such as an engine and a drive motor. The drive apparatus 212 generates the drive force of the wheels 220, according to manipulation of an acceleration pedal by a driver or operation instructions output from the vehicle control apparatus 210. The steering apparatus 214 includes an electric power steering system (EPS) ECU and an EPS actuator. The steering apparatus 214 changes the steering angle θs of the wheels 220 (front wheels 220f) according to manipulation of a steering wheel by the driver or operation instructions output from the vehicle control apparatus 210. The braking apparatus 216 includes a brake ECU and a brake actuator. The braking apparatus 216 generates braking force of the wheels 220 according manipulation of a braking pedal by the driver or operation instructions output from the vehicle control apparatus 210.

### [2. Vehicle Inspection System 10]

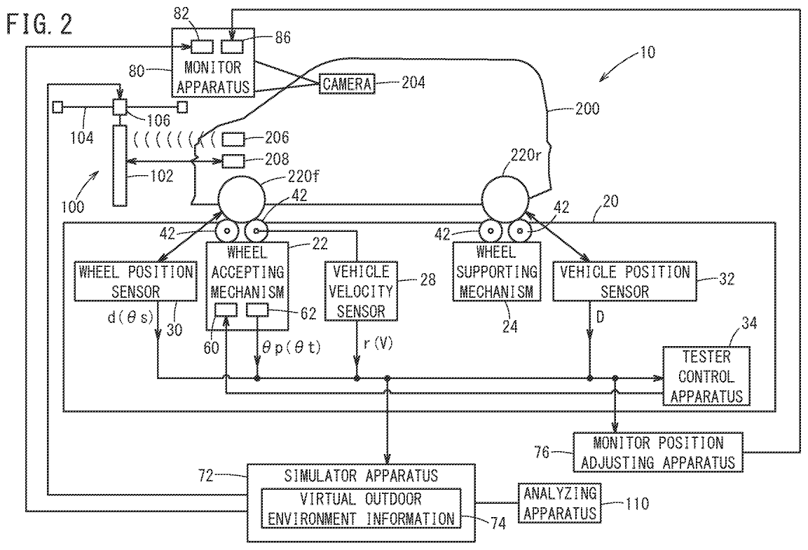

The following describes a vehicle inspection system 10 that inspects a driving function of the vehicle 200, using FIG. 2. The vehicle inspection system 10 includes a bench tester 20, a simulator apparatus 72, a monitor position adjusting apparatus 76, a monitor apparatus 80, a target apparatus 100, and an analyzing apparatus 110.

### [2.1. Bench Tester 20]

As shown in FIG. 2, the bench tester 20 includes a wheel accepting mechanism 22, a wheel support mechanism 24, a vehicle velocity sensor 28, a wheel position sensor 30, a vehicle position sensor 32, and a tester control apparatus 34. The following describes the bench tester 20 that performs an inspection of the vehicle 200 in which the front wheels 220f are the driving wheels and steered wheels.

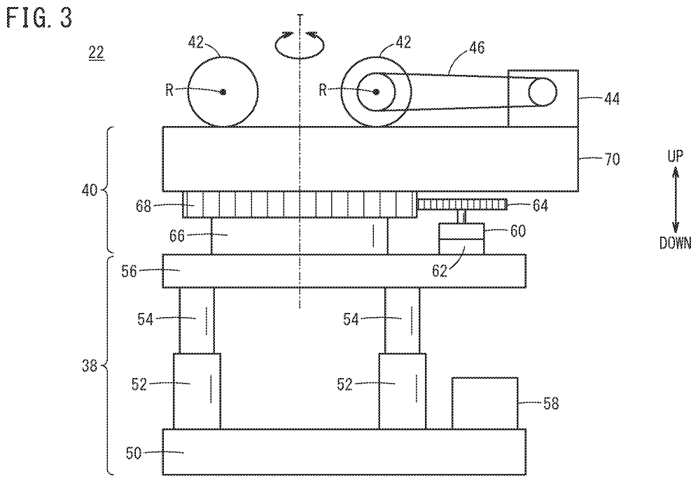

The wheel accepting mechanism 22 is positioned below a front wheel 220f of the vehicle 200 loaded on the bench tester 20, and is a mechanism that supports the front wheel 220f in a manner to be rotatable and turnable. As shown in FIG. 3, the wheel accepting mechanism 22 includes an elevating mechanism 38, a turning mechanism 40, and two rollers 42. The wheel accepting mechanism 22 is capable of causing the two rollers 42 to turn centered on a turning axis T that is parallel to the vertical direction, in accordance with a steering operation of the front wheel 220f, and is also capable of raising and lowering the two rollers 42 in the vertical direction.

The elevating mechanism 38 includes a base platform 50, a plurality of cylinders 52, a plurality of pistons 54, a raising/lowering platform 56, and a height adjusting apparatus 58. The base platform 50 is positioned at the bottommost portion of the wheel accepting mechanism 22, and is fixed to the body of the bench tester 20. Each cylinder 52 is a fluid pressure cylinder (pneumatic cylinder or hydraulic cylinder) that is fixed to the base platform 50. Each piston 54 rises in response to the supply of fluid to the corresponding cylinder 52, and lowers in response to the discharge of fluid from the cylinder 52. The raising/lowering platform 56 is supported from below by the pistons 54, and performs a raising and lowering operation in response to the operation of the pistons 54. The height adjusting apparatus 58 is an apparatus (pump, pipe, electromagnetic valve, and the like) that supplies fluid to the cylinders 52 and discharges fluid from the cylinders 52. The electromagnetic valve of the height adjusting apparatus 58 operates according to a pilot signal output from the tester control apparatus 34. The fluid is switched between being supplied to and discharged from the cylinders 52 according to the operation of the electromagnetic valve. The elevating mechanism 38 may be operated by electricity instead of by fluid pressure. Furthermore, the support provided by the pistons 54 may be augmented by a stopper (not shown in the drawings).

The turning mechanism 40 includes a swing motor 60, a rotation sensor 62, a first gear 64, a support platform 66, a second gear 68, and a turning platform 70. The swing motor 60 is fixed to the raising/lowering platform 56. The rotation sensor 62 and the first gear 64 are fixed to an output shaft of the swing motor 60. The swing motor 60 operates with electric power supplied from the tester control apparatus 34. The rotation sensor 62 is constituted by a rotary encoder, for example. The rotation sensor 62 detects a rotational position θp of the swing motor 60. The rotational position θp corresponds to a turning angle θt of the rollers 42 (turning platform 70). The support platform 66 is fixed on the top surface of the raising/lowering platform 56. The second gear 68 is supported by the support platform 66 in a manner to be rotatable centered on a turning axis T parallel to the vertical direction. Furthermore, teeth formed on the circumferential surface of the second gear 68 interlock with teeth formed on the circumferential surface of the first gear 64. The turning platform 70 is attached to the top surface of the second gear 68, and rotates about the turning axis T along with the rotation of the second gear 68.

The two rollers 42 are supported by the turning platform 70 in a manner to be rotatable about rotational axes R parallel to the horizontal plane. Among the two rollers 42, one contacts a front surface of a bottom portion of the front wheel 220f and the other contacts a rear surface of the bottom portion of the front wheel 220f, thereby rotatably supporting the front wheel 220f. When the front wheel 220f is in a neutral state of not being turned leftward or rightward (when the steering angle θs is zero), the axial lines of the two rollers 42 are parallel to the vehicle width direction. A crawler belt may be used instead of the two rollers 42. One of the two rollers 42 is coupled to an output shaft of the torque motor 44 via a belt 46. The torque motor 44 can place a virtual load on a wheel 220 by applying torque around the rotational axis R of the roller 42. The torque motor 44 operates with electric power supplied from the tester control apparatus 34.

Returning to FIG. 2, the description of the bench tester 20 will be continued. The wheel support mechanism 24 is a mechanism that is positioned below a rear wheel 220r of the vehicle 200 loaded on the bench tester 20, and supports the rear wheel 220r in a manner to be rotatable. The wheel support mechanism 24 includes two rollers 42. The two rollers 42 are supported in a manner to be rotatable about rotational axes parallel to the axial direction.

The vehicle velocity sensor 28 is constituted by a rotary encoder, a resolver, or the like, for example. The vehicle velocity sensor 28 detects the rotational velocity r of one of the rollers 42 provided to the wheel accepting mechanism 22. The rotational velocity r corresponds to the vehicle velocity V. The wheel position sensor 30 is constituted by a laser ranging apparatus or the like. The wheel position sensor 30 detects the distance d from the wheel position sensor 30 to a prescribed portion on the front wheel 220f. The distance d corresponds to the steering angle θs of the vehicle 200. In other words, in the present embodiment, the wheel position sensor 30 is used as a wheel sensor that detects the steering direction and steering angle θs of the front wheel 220f. The vehicle position sensor 32 is constituted by a laser ranging apparatus or the like. The vehicle position sensor 32 detects a distance D from the vehicle position sensor 32 to a prescribed portion (sideward portion) of the vehicle 200. The distance D corresponds to a position in the vehicle width direction of the vehicle 200.

The tester control apparatus 34 is constituted by a computer, and includes a computing apparatus having a processor (CPU and the like), a storage apparatus (ROM, RAM, hard disk, and the like), an A/D conversion circuit, a communication interface, a driver, and the like. The computing apparatus of the tester control apparatus 34 realizes various functions by executing a program stored in the storage apparatus. Here, the computing apparatus controls the height adjusting apparatus 58, swing motor 60, and torque motor 44 of the wheel accepting mechanism 22. Furthermore, the computing apparatus gathers information detected by each sensor, and saves this data in the storage apparatus as a data log.

### [2.2. Simulator Apparatus 72]

The simulator apparatus 72 is constituted by a computer, and includes a computing apparatus having a processor (CPU and the like), a storage apparatus (ROM, RAM, hard disk, and the like), an A/D conversion circuit, a communication interface, a driver, and the like. The computing apparatus of the simulator apparatus 72 realizes various functions by executing a program stored in the storage apparatus. Here, the computing apparatus controls the monitor apparatus 80 and the target apparatus 100, in order to reproduce a virtual outdoor environment that simulates an outdoor environment. For example, the computing apparatus displays an image simulating the outdoor environment in a monitor 82. Furthermore, the computing apparatus gathers information detected by each sensor of the bench tester 20, and saves this information in the storage apparatus as a data log. The storage apparatus of the simulator apparatus 72 stores, in addition to various programs, virtual outdoor environment information 74 for simulating the outdoor environment. The virtual outdoor environment information 74 is information for reproducing a series of virtual outdoor environments. For example, the virtual outdoor environment information 74 includes image information output to the monitor 82, information concerning the initial position of the vehicle 200 in the virtual outdoor environment, information concerning the position of each object in the virtual outdoor environment, information concerning the behavior of moving targets, and the like.

### [2.3. Monitor Position Adjusting Apparatus 76]

The monitor position adjusting apparatus 76 is constituted by a computer, and includes a computing apparatus having a processor (CPU and the like), a storage apparatus (ROM, RAM, hard disk, and the like), an A/D conversion circuit, a communication interface, a driver, and the like. The computing apparatus of the monitor position adjusting apparatus 76 realizes various functions by executing a program stored in the storage apparatus. Here, the computing apparatus manipulates the moving motor 86 of the monitor apparatus 80 based on information concerning the steering direction detected by the wheel position sensor 30 (wheel sensor).

### [2.4. Monitor Apparatus 80]

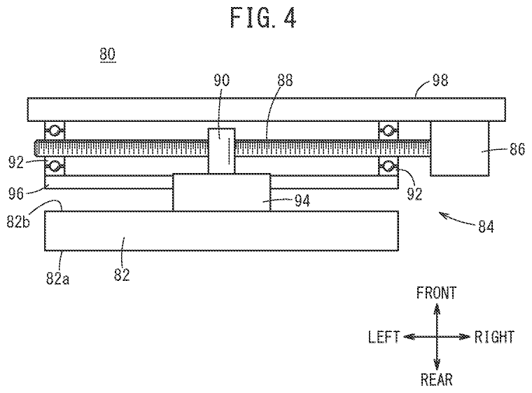

As shown in FIG. 4, the monitor apparatus 80 includes the monitor 82 and the monitor moving mechanism 84. The front-rear direction and left-right direction shown in FIG. 4 match the front-rear direction and left-right direction of the vehicle 200 loaded on the bench tester 20. The left-right direction matches the vehicle width direction of the vehicle 200.

The monitor 82 is arranged such that a screen 82a faces the camera 204 of the vehicle 200 in a state where the monitor 82 is oriented in the direction of the vehicle 200, that is, facing toward the rear. The monitor 82 displays an image simulating the outdoor environment in the screen 82a, based on the virtual outdoor environment information 74 transmitted from the simulator apparatus 72. A projector and screen may be used instead of the monitor 82.

The monitor moving mechanism 84 includes a moving motor 86, a ball screw shaft 88, a ball screw nut 90, a bearing 92, a table 94, and a slider 96. The moving motor 86 and the bearing 92 are fixed to a frame 98. The slider 96 is fixed to the frame 98, parallel to the left-right direction. An output shaft of the moving motor 86 is connected to the ball screw shaft 88 by a coupling or the like. The ball screw shaft 88 is arranged parallel to the left-right direction, and is supported by the bearing 92 in a manner to be rotatable about the axis thereof. The ball screw nut 90, which interlocks with the ball screw shaft 88, is fixed to the table 94. The table 94 is supported by the slider 96 in a manner to be movable in the left-right direction, and is fixed to a back surface 82b of the monitor 82.

The moving motor 86 operates with power supplied from the monitor position adjusting apparatus 76. In accordance with the rotation of the moving motor 86, the ball screw shaft 88 rotates and the ball screw nut 90 moves leftward or rightward. In accordance with the movement of the ball screw nut 90, the table 94 moves leftward or rightward along the slider 96. The monitor 82 moves leftward or rightward together with the table 94.

### [2.5. Target Apparatus 100]

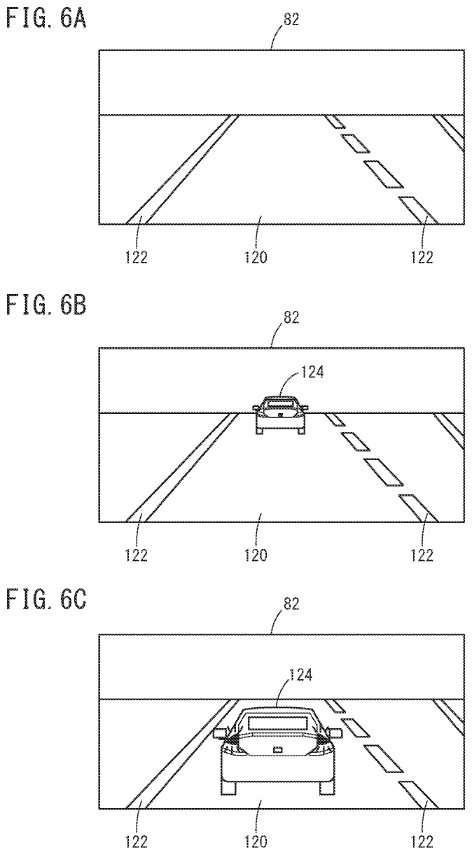

Returning to FIG. 2, the target apparatus 100 will be described. The target apparatus 100 includes a target 102, a guide rail 104, and an electric motor 106. The target 102 is arranged opposite the radar 206 and the LiDAR 208. The target 102 is a board that simulates a preceding vehicle 124 (FIG. 6B and the like). The target 102 is capable of moving in a direction toward and a direction away from the front of the vehicle 200, along the guide rail 104. The electric motor 106 operates according to power output from the simulator apparatus 72.

### [2.6. Analyzing Apparatus 110]

The analyzing apparatus 110 is formed by a computer that includes a processor, a storage apparatus, and an input/output apparatus. The analyzing apparatus 110 acquires a data log of the inspection from the simulator apparatus 72 or the bench tester 20.

### [3. Procedure for Inspecting a Driving Function of the Vehicle 200]

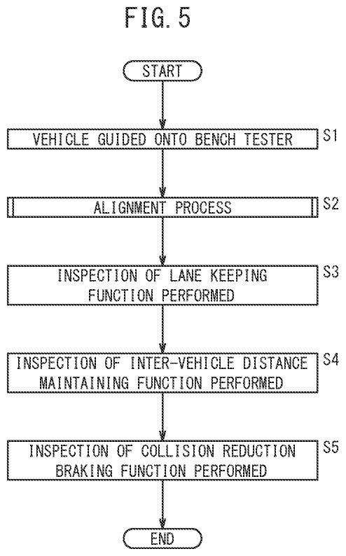

The following describes the procedure for inspecting a driving function of the vehicle 200 using the vehicle inspection system 10, while referencing FIG. 5. Here, it is assumed that inspections of a lane keeping function, an inter-vehicle distance maintaining function, and a collision reduction braking function are performed. The inspections below are performed in a state where a worker is riding in the vehicle 200.

At step S1, the vehicle 200 is guided onto the bench tester 20. At this time, the front wheels 220f are loaded on the rollers 42 of the wheel accepting mechanism 22 and the rear wheels 220r are loaded on the rollers 42 of the wheel support mechanism 24. After step S1 ends, the process moves to step S2.

At step S2, the alignment process of the monitor 82 and the vehicle 200 is performed. The alignment process is described in section [4] below. After step S2 ends, the process moves to step S3.

At step S3, the inspection of the lane keeping function is performed. In the inspection of the lane keeping function, a virtual outdoor environment showing a scene without obstacles (6A) is reproduced by the simulator apparatus 72. The simulator apparatus 72 reproduces this travel scene without obstacles based on the virtual outdoor environment information 74, and displays an image of the reproduced scene in the monitor 82. As shown in FIG. 6A, the monitor 82 displays a travel lane 120 with dividing lines 122 provided on the left and right thereof, as the virtual outdoor environment. The camera 204 of the vehicle 200 captures the image displayed in the monitor 82. On the other hand, the radar 206 and the LiDAR 208 are covered by an electromagnetic wave absorber (not shown in the drawings), thereby producing the virtual outdoor environment without obstacles, that is, an environment where electromagnetic waves are not reflected.

The worker manipulates a switch provided to the vehicle 200 in advance to activate the lane keeping function. The vehicle control apparatus 210 controls acceleration and deceleration according to the manipulation of the acceleration pedal and brake pedal by the worker, and controls steering such that the vehicle 200 travels in the center of the travel lane 120 based on the detection results of the outside sensor 202.

The simulator apparatus 72 calculates a movement amount and a progression direction of the vehicle 200 based on the vehicle velocity V detected by the vehicle velocity sensor 28 and the steering angle θs detected by the wheel position sensor 30. The simulator apparatus 72 then moves the vehicle 200 in the virtual outdoor environment according to the calculated movement amount and progression direction, and reproduces the virtual outdoor environment near an after-movement position. The monitor 82 displays a latest virtual outdoor environment reproduced by the simulator apparatus 72. As a result, the image displayed in the monitor 82 progresses in synchronization with the operation of the vehicle 200. Also for the inspections of step S4 and step S5 described below, the simulator apparatus 72 causes the image displayed in the monitor 82 to progress in synchronization with the operation of the vehicle 200.

In order to have the turning operation of the rollers 42 track the steering operation of the front wheels 220f, the tester control apparatus 34 causes the swing motor 60 of the turning mechanism 40 to operate based on the steering angle θs detected by the wheel position sensor 30. At this time, the tester control apparatus 34 controls the swing motor 60 (feedback control) such that the turning angle θt detected by the rotation sensor 62 tracks the steering angle θs. In this way, the tester control apparatus 34 causes the rollers 42 to be orthogonal to the front wheels 220f (causes the rotational axes R of the rollers 42 to be parallel to the vehicle axle of the front wheels 220f). The tester control apparatus 34 causes the swing motor 60 of the wheel accepting mechanism 22 to operate in the same manner in the inspections of step S4 and step S5 below. After step S3 ends, the process moves to step S4.

At step S4, the inspection of the inter-vehicle distance maintaining function is performed. In the inspection of the inter-vehicle distance maintaining function, a virtual outdoor environment showing a scene in which the preceding vehicle 124 is travelling (FIG. 6B) is reproduced by the simulator apparatus 72. The simulator apparatus 72 reproduces the scene in which the preceding vehicle 124 is travelling based on the virtual outdoor environment information 74, and displays an image of the reproduced scene in the monitor 82. As shown in FIG. 6B, the monitor 82 displays the preceding vehicle 124, travelling a prescribed distance ahead of the virtual travel position of the vehicle 200, along with the travel lane 120 as the virtual external environment. The camera 204 of the vehicle 200 captures the image displayed on the monitor 82.

Furthermore, the simulator apparatus 72 controls the operation of the electric motor 106 such that the position of the target 102 matches the position of the preceding vehicle 124 in the virtual outdoor environment information 74. The electric motor 106 of the target apparatus 100 operates with the power output from the simulator apparatus 72, and moves the target 102 to the position of the preceding vehicle 124 in the virtual outdoor environment. The radar 206 and the LiDAR 208 of the vehicle 200 detect the target 102.

The worker manipulates a switch provided to the vehicle 200 in advance to activate the inter-vehicle distance maintaining function. The vehicle control apparatus 210 controls steering according to the manipulation of the steering wheel by the worker, and controls acceleration and deceleration such that the vehicle 200 travels while maintaining the inter-vehicle distance with respect to the preceding vehicle 124 based on the detection results of the outside sensor 202. After step S4 ends, the process moves to step S5.

At step S5, the inspection of the collision reduction braking function is performed. In the inspection of the collision reduction braking function, a virtual outdoor environment showing a scene in which the preceding vehicle 124 stops suddenly (FIG. 6C) is reproduced by the simulator apparatus 72. The simulator apparatus 72 reproduces the scene in which the preceding vehicle 124 stops suddenly based on the virtual outdoor environment information 74, and displays an image of the reproduced scene in the monitor 82. As shown in FIG. 6C, the monitor 82 displays the preceding vehicle 124 that stops suddenly in front of the vehicle 200, that is, the preceding vehicle 124 that quickly approaches the vehicle 200, along with the travel lane 120 as the virtual outdoor environment. The camera 204 of the vehicle 200 captures the image displayed on the monitor 82.

Furthermore, the simulator apparatus 72 controls the operation of the electric motor 106 such that the position of the target 102 matches the position of the preceding vehicle 124 in the virtual outdoor environment information 74. The electric motor 106 of the target apparatus 100 operates due to the power output from the simulator apparatus 72, and causes the target 102 to quickly approach the vehicle 200. The radar 206 and LiDAR 208 of the vehicle 200 detect the target 102.

After the inspections end, an analysis of the data log is performed by the analyzing apparatus 110. For example, a comparison is made between data showing an operational model of the vehicle 200 for the reproduced virtual outdoor environment and the data log that is actually acquired. If the differences between the data and the data log is within a tolerable range, the outside sensor 202, vehicle control apparatus 210, drive apparatus 212, steering apparatus 214, and braking apparatus 216 of the vehicle 200 can be determined to be operating correctly.

### [4. Procedure of the Alignment Process]

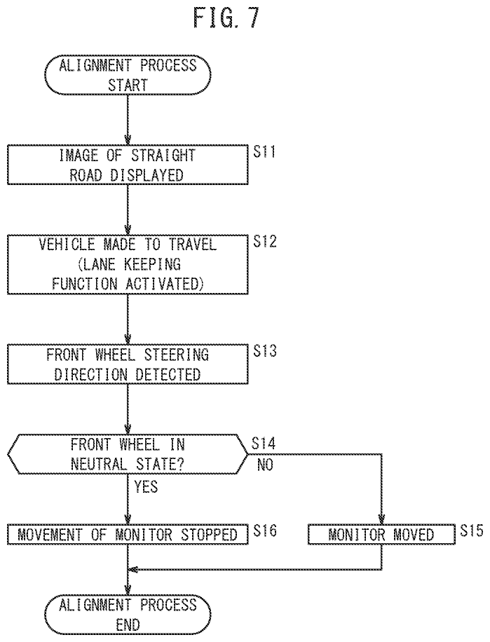

The following describes a procedure of the alignment process (step S2 of FIG. 5), using FIG. 7.

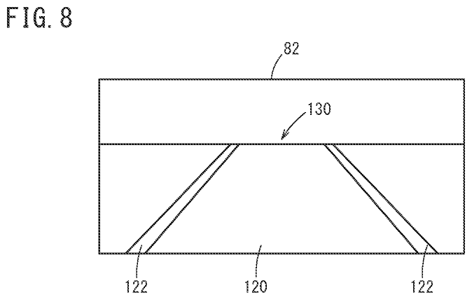

At step S11, the simulator apparatus 72 reproduces a straight road 130 without obstacles based on the virtual outdoor environment information 74, and displays an image of the reproduced straight road 130 on the monitor 82. As shown in FIG. 8, the monitor 82 displays the travel lane 120 of the straight road 130 provided with the dividing lines 122 on the left and right thereof, as the virtual outside environment. At this time, the simulator apparatus 72 adjusts the display position of the travel lane 120 such that the center position of the travel lane 120 in the width direction matches a center position of the screen 82a in the width direction. The camera 204 of the vehicle 200 captures the image displayed on the monitor 82. On the other hand, the radar 206 and the LiDAR 208 are covered by an electromagnetic wave absorber (not shown in the drawings), thereby producing the virtual outdoor environment without obstacles, that is, an environment where electromagnetic waves are not reflected.

At step S12, the worker causes the vehicle 200 to travel on the bench tester 20. At this time, the worker manipulates a switch provided to the vehicle 200 to activate the lane keeping function. When this happens, the vehicle 200 performs steering control to travel at a prescribed position within the travel lane 120 based on the image of the monitor 82 captured by the camera 204. In the present embodiment, when the lane keeping function is active, the vehicle control apparatus 210 performs steering control such that the center position of the vehicle 200 in the vehicle width direction matches the center position of the travel lane 120 in the vehicle width direction.

At step S13, the wheel sensor, i.e. the wheel position sensor 30, detects the steering direction and steering angle θs of the front wheel 220f.

At step S14, the monitor position adjusting apparatus 76 judges whether the front wheel 220f is in the neutral state, based on the detection results of the wheel sensor. For example, the monitor position adjusting apparatus 76 judges that the front wheel 220f is in the neutral state if the difference between the detected distance d and a prescribed value (prescribed distance d given when the steering angle θs is zero degrees) is within a prescribed range. If the front wheel 220f is in the neutral state (step S14: YES), the process moves to step S16. On the other hand, if the front wheel 220f is not in the neutral state (step S14: NO), the process moves to the step S15.

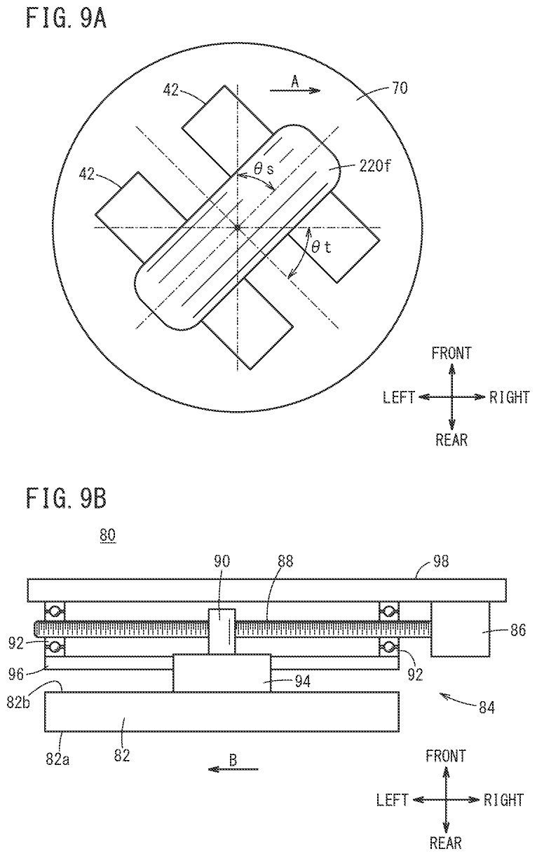

At step S15, the monitor position adjusting apparatus 76 supplies power to the moving motor 86 of the monitor moving mechanism 84 to move the monitor 82. At this time, the monitor position adjusting apparatus 76 moves the monitor 82 in a direction opposite the steering direction of the front wheel 220f. For example, as shown in FIG. 9A, the steering of the front wheel 220f toward the right (A direction) performed by the lane keeping function occurs when the vehicle 200 is travelling farther to the left side than a prescribed position within the travel lane 120. This means that, relative to the vehicle 200, the monitor 82 is positioned to the right side of the optimal position. The optimal position refers to the position of the monitor 82 relative to the vehicle 200 in a state where the monitor 82 and the vehicle 200 are aligned. Accordingly, as shown in FIG. 9B, the monitor position adjusting apparatus 76 moves the monitor 82 toward the left (B direction), which is the direction opposite the steering direction. As the monitor 82 becomes closer to the optimal position, the vehicle control apparatus 210 of the vehicle 200 recognizes that the vehicle 200 is approaching the prescribed position within the travel lane 120 and reduces the steering amount. As a result, the steering angle θs of the front wheel 220f becomes smaller. The process of step S15 is performed repeatedly until the front wheel 220f enters the neutral state (step S14: YES).

At step S16, the monitor position adjusting apparatus 76 stops the supply of power to the moving motor 86 of the monitor moving mechanism 84, thereby stopping the movement of the monitor 82. At this time, the monitor 82 is at the optimal position, and the vehicle control apparatus 210 of the vehicle 200 recognizes that the vehicle 200 is travelling at the prescribed position within the travel lane 120. As a result, the vehicle control apparatus 210 sets the front wheel 220f to the neutral position (steering angle θs≈0 degrees). After the above, the alignment process of the monitor 82 and the vehicle 200 ends. After the alignment, the center position of the vehicle 200 in the vehicle width direction matches the center position of the travel lane 120 in the width direction.

### [5. Procedure of a Lateral Skew Preventing Process]

When there is skew between the turning angle θs of the front wheel 220f and the turning angle θt of the rollers 42 (turning platform 70), a lateral force occurs that pushes the vehicle 200 sideways. The lateral force also occurs when the steering of the front wheel 220f starts, that is, during a period from when the EPS actuator starts operating in response to the steering instructions output by the vehicle control apparatus 210 to before the steering angle θs of the front wheel 220f actually starts changing. If the lateral force is large, the vehicle 200 becomes skewed sideways relative to the rollers 42. As described above, the tester control apparatus 34 converts the rotational position θp detected by the rotation sensor 62 into the turning angle θt, and performs feedback control on the swing motor 60 such that the turning angle θt tracks the steering angle θs detected by the wheel position sensor 30. Due to this feedback control, it is possible to reduce the lateral skew caused by the skew between the steering angle θs and the turning angle θt. However, this feedback control cannot be applied to lateral skew occurring when the steering of the front wheel 220f starts.

Therefore, the tester control apparatus 34 may control the turning operation of the rollers 42 using a double-feedback method. Specifically, the tester control apparatus 34 controls the turning operation of the rollers 42 (turning platform 70) based on the distance d (steering angle θs) detected by the wheel position sensor 30 and the distance D (position in the vehicle width direction) detected by the vehicle position sensor 32. The following describes an example of this. With zero degrees as a boundary, the steering angle θs is a positive value when on one side, among the left and right side, and is a negative value when on the other side. The turning angle θt is treated in the same manner. With the distance D detected by the vehicle position sensor 32 in a state where the monitor 82 and the vehicle 200 are aligned (referred to below as Ds) as a boundary, the distance D is a positive value when on one side, among the left and right side, and is a negative value when on the other side.

The tester control apparatus 34 stores in advance information indicating a correspondence relationship between the difference between the distance D and distance Ds and the turning amount of the swing motor 60 that can make this difference become zero.

The tester control apparatus 34 corrects the distance d detected by the wheel position sensor 30, by the lateral skew amount of the vehicle 200, and calculates the steering angle θs. For example, the tester control apparatus 34 calculates the steering angle θs by subtracting the lateral skew amount (D−Ds) from the distance d. The tester control apparatus 34 then calculates the turning angle θt of the rollers 42 at this time based on the rotational position θp detected by the rotation sensor 62, and controls the swing motor 60 such that the turning angle θt approaches the steering angle θs. Furthermore, the tester control apparatus 34 controls the swing motor 60 such that the distance D detected by the vehicle position sensor 32 approaches the distance Ds. In this way, the tester control apparatus 34 performs feedback control of the distance d (steering angle θs) and feedback control of the distance D. In the feedback control of the distance D, the tester control apparatus 34 controls the swing motor 60 in a manner to turn the rollers 42 to the left if the lateral skew of the vehicle 200 is to the left and to turn the rollers 42 to the right if the lateral skew of the vehicle 200 is to the right.

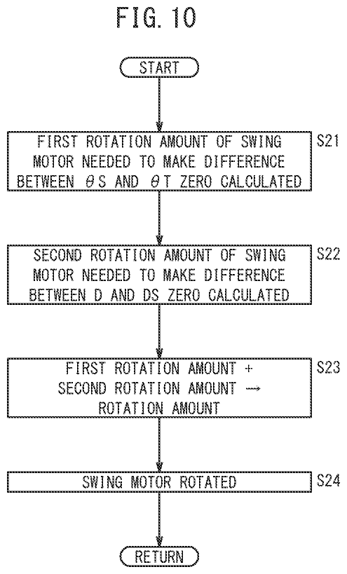

The following describes a specific example of the lateral skew preventing process, using FIG. 10. The lateral skew preventing process is performed in the process shown in FIG. 5 and the process shown in FIG. 7, while the vehicle 200 is travelling on the bench tester 20.

At step S21, the tester control apparatus 34 obtains the rotation amount of the swing motor 60 needed to make the difference between the steering angle θs of the front wheel 220f and the turning angle θt of the rollers 42 zero. The rotation amount obtained here is referred to as a first rotation amount. After step S21, the process moves to step S22.

At step S22, the tester control apparatus 34 obtains the rotation amount of the swing motor 60 needed to make the difference between the distance D and the distance Ds zero, using information that has been stored in advance. The rotation amount obtained here is referred to as a second rotation amount. After step S22, the process moves to step S23.

At step S23, the tester control apparatus 34 obtains the rotation amount of the swing motor 60 by adding together the first rotation amount obtained in step S21 and the second rotation amount obtained in step S22. After step S23, the process moves to step S24.

At step S24, the tester control apparatus 34 supplies the swing motor 60 with power corresponding to the rotation amount obtained in step S23, to rotate the swing motor 60.

### [6. Modifications and Other Embodiments]

In the embodiment described above, the monitor position adjusting apparatus 76 manipulates the monitor moving mechanism 84 to move the monitor 82 in a direction opposite the steering direction of the wheels 220. Instead, the position of the monitor 82 can be left as is, and the simulator apparatus 72 can perform display control of the monitor 82 to move the image displayed in the monitor 82 in the direction opposite the steering direction of the wheels 220. In this case, the simulator apparatus 72 may move the entire image, or may move only a portion of the image (the straight road 130).

In each of the inspections described in Section [3] above, in order to more closely approximate the actual travel state, a load corresponding to the virtual outdoor environment may be placed by the torque motor 44 on the front wheels 220f, which are the driving wheels. Furthermore, the elevating mechanism 38 may be operated to reproduce a virtual outdoor environment simulating a sloped surface such as a down-hill or up-hill slope.

In the embodiment above, the bench tester 20 that inspects the vehicle 200 in which the front wheels 220f are the driving wheels has been described. On the other hand, when inspecting a vehicle 200 in which the rear wheels 220r are the driving wheels, the vehicle velocity sensor 28 detects the rotational velocity r of one of the rollers 42 of the wheel support mechanism 24 supporting a rear wheel 220r.

In the above embodiment, the vehicle inspection system 10 inspects each function of a driving assistance vehicle. As another embodiment, the vehicle inspection system 10 can inspect each function of an automated driving vehicle.

[7. Technical Concepts Obtainable from the Embodiments]

The following is a record of technical concepts that can be understood from the embodiments and modifications above.

A first aspect of the present invention is a vehicle inspection system 10 that inspects a driving function of a vehicle 200 performing automated driving or driving assistance, wherein: the vehicle 200 has a lane keeping function for capturing an image of an outdoor environment in front of the vehicle 200 with a camera 204 and keeping a travel position at a prescribed position within a travel lane 120 by performing steering based on the acquired image information, the vehicle inspection system 10 comprising: a bench tester 20 including a wheel accepting mechanism 22 that supports a wheel 220 (front wheel 220f) of the vehicle 200 and accepts a rotating operation and a steering operation of the wheel 220; a monitor 82 arranged facing the camera 204; a simulator apparatus 72 that displays an image simulating the outdoor environment on the monitor 82; a wheel sensor (wheel position sensor 30) that detects a steering direction of the wheel 220; and an image position adjusting apparatus (monitor position adjusting apparatus 76) that moves the image in a direction of a vehicle width of the vehicle, based on information concerning the steering direction detected by the wheel sensor; wherein when the monitor 82 and the vehicle 200 are aligned on the bench tester 20: the simulator apparatus 72 displays the image of a straight road 130 on the monitor 82; the wheel sensor detects the steering direction of the wheel 220 steered by the lane keeping function; and the image position adjusting apparatus (monitor position adjusting apparatus 76) moves the image in a direction opposite the steering direction of the wheel 220 until the wheel 220 enters a neutral state of not being steered.

When the vehicle 200 that has activated the lane keeping function is travelling on the bench tester 20 and the camera 204 captures the image of the straight road 130 displayed on the monitor 82, the vehicle control apparatus 210 performs steering control to align the travel position with the center position of the straight road 130 in the width direction. Then, when the center position of the vehicle 200 in the vehicle width direction matches the center position of the screen 82a of the monitor 82 in the width direction, the vehicle control apparatus 210 performs the steering control to put the wheels 220 in the neutral state. The above configuration utilizes such functions of the vehicle 200.

According to the above configuration, the alignment of the monitor 82 and the vehicle 200 is performed using the lane keeping function of the vehicle 200 without using a specialized apparatus such as a confronting apparatus, and therefore it is possible to reduce the cost of alignment. Furthermore, according to the above configuration, whether the monitor 82 needs to be moved to the left or right is judged according to whether the vehicle 200 is being steered and the monitor 82 is only moved based on this judgment, and therefore it is possible to easily perform the alignment of the monitor 82 and the vehicle 200.

The vehicle inspection system 10 may comprise a monitor moving mechanism 84 that moves the monitor 82 in the vehicle width direction of the vehicle 200; wherein the image position adjusting apparatus (monitor position adjusting apparatus 76) may manipulate the monitor moving mechanism 84 to move the image in a direction opposite the steering direction of the wheel 220.

In the first aspect, the wheel sensor (wheel position sensor 30) may detect the steering angle θs of the wheel 220 (front wheel 220f); the wheel accepting mechanism 22 may comprise: a pair of rollers 42 that rotatably support the wheel 220; and a turning mechanism 40 that turns the pair of rollers 42 about a turning axis T parallel to a vertical direction, according to the steering of the wheel 220; and the vehicle inspection system 10 may further comprise a tester control apparatus 34 that manipulates the turning mechanism 40 to cause the turning operation of the pair of rollers 42 to track the steering operation of the wheel 220, based on information concerning the steering angle θs detected by the wheel sensor.

According to the above configuration, it is possible to reduce lateral force and lateral skew affecting the vehicle 200 due to steering of the wheel 220 on the rollers 42.

A second aspect of the present invention is an alignment method comprising loading onto a bench tester 20 a vehicle 200 that performs automated driving or driving assistance based on image information acquired by a camera 204, capturing an image simulating an outdoor environment displayed in a monitor 82 with the camera 204, and aligning the monitor 82 with the vehicle 200 when inspecting a driving function of the vehicle 200, wherein: the vehicle 200 has a lane keeping function for capturing an image of an outdoor environment in front of the vehicle 200 with the camera 204 and keeping a travel position at a prescribed position within a travel lane 120 by performing steering based on the acquired image information, the alignment method comprising: a step (step S11) of displaying the image of a straight road 130 on the monitor 82; a step (step S12) of activating the lane keeping function while capturing the image displayed on the monitor 82 with the camera 204, and causing the vehicle 200 to travel on the bench tester 20; a step (step S13) of detecting a steering direction of a wheel 220 (front wheel 220f) steered by the lane keeping function with a wheel sensor (wheel position sensor 30); and a step (steps S14 to step S16) of moving the image in a direction opposite the steering direction of the wheel 220, until the wheel 220 is in a neutral state of not being steered.

According to the above configuration, effects that are the same as those of the first aspect are achieved.

The vehicle inspection system and alignment method according to the present invention are not limited to the above-described embodiments, and it goes without saying that various modifications could be adopted therein without departing from the essence and gist of the present invention.

What is claim is:

1. A vehicle inspection system that inspects a driving function of a vehicle performing automated driving or driving assistance, wherein:
the vehicle has a lane keeping function for capturing an image of an outdoor environment in front of the vehicle with a camera and keeping a travel position at a prescribed position within a travel lane by performing steering based on the acquired image information, the vehicle inspection system comprising:
a bench tester including a wheel accepting mechanism that supports a wheel of the vehicle and accepts a rotating operation and a steering operation of the wheel;
a monitor arranged facing the camera;
a simulator apparatus that displays on the monitor an image simulating the outdoor environment;
a wheel sensor that detects a steering direction of the wheel; and
an image position adjusting apparatus that moves the image in a direction of a vehicle width of the vehicle, based on information concerning the steering direction detected by the wheel sensor; wherein
when the monitor and the vehicle are aligned on the bench tester:
the simulator apparatus displays the image of a straight road on the monitor;
the wheel sensor detects the steering direction of the wheel steered by the lane keeping function; and
the image position adjusting apparatus moves the image in a direction opposite the steering direction of the wheel until the wheel enters a neutral state of not being steered.

2. The vehicle inspection system according to claim 1, comprising:
a monitor moving mechanism that moves the monitor in the vehicle width direction of the vehicle; wherein
the image position adjusting apparatus manipulates the monitor moving mechanism to move the image in a direction opposite the steering direction of the wheel.

3. The vehicle inspection system according to claim 1, wherein:
the wheel sensor detects the steering angle of the wheel;
the wheel accepting mechanism comprises:
a pair of rollers that rotatably support the wheel; and
a turning mechanism that turns the pair of rollers about a turning axis parallel to a vertical direction, according to the steering of the wheel; and
the vehicle inspection system further comprises a tester control apparatus that manipulates the turning mechanism to cause the turning operation of the pair of rollers to track the steering operation of the wheel, based on information concerning the steering angle detected by the wheel sensor.

4. An alignment method comprising loading onto a bench tester a vehicle that performs automated driving or driving assistance based on image information acquired by a camera, capturing an image simulating an outdoor environment displayed in a monitor with the camera, and aligning the monitor with the vehicle when inspecting a driving function of the vehicle, wherein:
the vehicle has a lane keeping function for capturing an image of an outdoor environment in front of the vehicle with the camera and keeping a travel position at a prescribed position within a travel lane by performing steering based on the acquired image information, the alignment method comprising:
a step of displaying the image of a straight road on the monitor;
a step of activating the lane keeping function while capturing the image displayed on the monitor with the camera, and causing the vehicle to travel on the bench tester;
a step of detecting with a wheel sensor a steering direction of a wheel steered by the lane keeping function; and
a step of moving the image in a direction opposite the steering direction of the wheel, until the wheel is in a neutral state of not being steered.
